(19) United States
(12) Patent Application Publication
(10) Pub. No.: US 2021/0354575 A1
(43) Pub. Date: Nov. 18, 2021

(54) SMART CHARGING CABLE

(71) Applicant: dcbel Inc., Montréal (CA)

(72) Inventors: Hani VAHEDI, Brossard (CA); Marc-andré FORGET, Saint Lazare (CA); Ronald DENOM, Westmount (CA)

(21) Appl. No.: 17/284,006

(22) PCT Filed: Oct. 11, 2019
(86) PCT No.: PCT/CA2019/051456

§ 371 Date: Apr. 9, 2021

Related U.S. Application Data
(60) Provisional application No. 62/744,322, filed on Oct. 11, 2018.

(51) Int. Cl. B60L 53/18; B60L 53/16; B60L 53/68; B60L 53/30; G06K 9/00; H01B 9/00; H02J 7/00

(52) U.S. Cl. CPC B60L 53/18; B60L 53/16; B60L 53/68; B60L 53/305; H02J 2207/40; H01B 9/003; H02J 7/00034; H02J 7/0032; H02J 7/0042; G06K 9/00087

(57) ABSTRACT

In one aspect the present disclosure provides a system for charging electric vehicles both AC and DC using only two conductors comprising a cable having two ends one of which is attached to a connector and the other end to a plug and only two charging conductors that extend from one end of the cable to the other and either, one or more switches to receive the current from an AC or DC input and direct it based on a type of the current to an AC or DC output and to stop the current if the corresponding port is not available. The system also has a control mechanism for preventing the delivery of the current to the wrong port of the connector.

### CROSS-REFERENCE TO RELATED APPLICATIONS

This application claims priority from U.S. Provisional Patent Application 62/744,322 filed Oct. 11, 2018, the specification of which is incorporated herein by reference.

### FIELD OF THE INVENTION

The subject matter of the present application generally relates to the field of battery charging systems such as are used in, e.g., electric vehicles and more specifically to the field of electrical charging cables.

### BACKGROUND

In recent years, there has been a surge in the number of automobiles being operated in the world. Electric vehicles (EV) have been increasingly considered as one of the effective ways of reducing carbon emission and air pollution. This has led to many jurisdictions passing laws to control air pollution from automobiles. Such regulations are constantly becoming stricter each year.

Currently, a typical electric vehicle (EV) comprises a battery bank and battery charging system. The battery bank typically requires direct current (DC) input to charge the batteries. To that end, an onboard charging circuit is provided that converts AC power typically found in the home to a DC input for the battery bank. Most EV models also provide for DC charging that by-passes the onboard AC to DC converter.

The charging mode defines the safety communication protocol between the EV and charging station. These standards are generally similar worldwide. Mode 1 cables are commonly used for home charging from a standard AC power outlet using a simple extension cord, without any safety measures relates to the connection of the EV. Mode 1 connectors do not require any control pin from IEC 61851-1 and in some countries like the USA, mode 1 charging is prohibited by national codes. The main reason is that the required earthing is not present in all domestic installations so that Mode 2 was defined as an interim solution.

Mode 2 cable, which is normally used for home charging from a standard AC power outlet, but with a special in-cable EV Supply Equipment (EVSE), also known as an “occasional use cable,” is usually supplied with an EV from the manufacturer. This cable provides an in-cable residual-current device (RCD), over-current protection, over-temperature protection, protective Earth detection from a wall socket. However, most automotive original equipment manufacturers (OEM) insist on installing a proper Mode-3 home charging station (“wall-box”) in the EV owner's garage for continuous use. Mode 3 provides a wired-in AC charging station, either in public places or at home, allowing a higher power level than Mode 2. The safety protocol is normally similar to Mode 2. According to IEC 61851-1, Mode 3 connectors require a range of control and signal pins for both sides of the cable. Mode 4 provides a wired-in DC charging station, either in public places or at home. In DC charging stations, the charger is part of the charging station, not part of the car.

As explained, there are several different world standards; there has been a lot of effort towards adopting a new combo plug that could offer the flexibility of charging the vehicle both in an AC mode or DC mode using the same cable. Currently, there are different versions of combo plugs and cables that due to having multiple wires for transmitting DC, AC, ground, and control are typically heavy and hard to operate.

Furthermore, there still exist different versions of combo plug and wires which are not compatible with each other. Moreover, these types of plug and cables do not have any coupling structure capable of reducing the risk of having a charging cable stolen during charging.

In view of the above, it is apparent that there exists a need for a cable assembly for transferring energy to electric vehicles from electrical charging stations which will overcome the above problems of the prior art and which is convenient to operate as well as capable of selectively receiving both direct electrical current and alternating electrical current. This invention addresses these needs in the art along with other needs which will become apparent to those skilled in the art once given this disclosure.

### SUMMARY

The present disclosure provides, inter alia, novel and innovative solutions for the above-mentioned needs in the art which will become apparent to those skilled in the art once given this disclosure.

In one broad aspect, the present disclosure provides a system for charging an electric vehicle, the system comprising a cable having a first end and a second end. The cable comprising a first and a second conductor capable of conducting both AC current and DC current upon request, each extending from said first end to said second end. A plug connects the first end of the cable to a power supply and a connector connects the second end to the electric vehicle. In some embodiments, such a connection may need an adaptor such as a connector adaptor or a plug adaptor.

In some embodiments, the system further comprises a sensing system for detecting a type of the current and a mechanism allowing an AC or DC adaptor to connect to the connector according to said type of said current.

In some alternative embodiments, the system further comprises a sensing system for detecting a type of the current, a first switch in the plug to receive the current from an AC or DC input of said power supply, a second switch in the connector for directing the current to an AC and DC ports; a control unit to control the first and second switches in accordance with the type of the current. The control unit is configured to stop the current when said type of the current is not acceptable by said electric vehicle.

In some embodiments, the system comprises a sensing system detecting the type of the current, a control unit configured to control a switch to stop the current when the type of the current is not acceptable by the electric vehicle.

In one embodiment, the sensing system may be an ID reader for reading the ID of a charge port of the electric vehicle and communicating the vehicle's current information with the switch and a power supply to deliver said current accordingly.

In one alternative embodiment, the sensing system may be a current sensor attached to said cable communicating the type of current to the control unit controlling said switch to direct the current to deliver the current accordingly.

In one alternative embodiment, the control unit may communicate with an end device to choose the current type and the current to the electric vehicle.

In one alternative embodiment, the cable may further comprise a protective earthing conductor extending from the first and to the second. The cable may also have one or more signal cables extending from the first and to the second and transfers data between the power supply and the electric vehicle.

In one aspect, the system has a cable that may further comprise a first phase-locked loop configured to connect to the signal cable of the electric vehicle and to the protective earthing conductor and a second phase-locked loop may to connect to a signal cable of the power supply and to the protective earthing conductor. The first phase-locked loop and the second phase-locked loop transmit the signal between the power supply and the electric vehicle through said protective earthing conductor.

In some embodiments, the system may comprise a connector adaptor wherein the connector uses a connector adaptor to connect to the charge port of the electric vehicle.

In one embodiment, the system further comprises a biometric recognition system which is used to confirm the identity of a user before allowing the current from the power supply to the electric vehicle.

In another broad aspect, the present disclosure provides a charging cable for AC and DC charging with only two charging conductors. The cable comprising a first and a second conductor capable of conducting both AC and DC upon request, each extending from said first end to said second end, a connector attached to the second and having an AC port and a DC port.

In some embodiments, the cable further comprises a sensing system for detecting a type of said current and a mechanism allowing an AC or DC adaptor to connect to the connector according to said type of said current.

In some alternative embodiments, the cable comprises a sensing system for detecting a type of said current, a first switch in said plug to receive said current from an AC or DC input of said power supply, a second switch in said connector for directing the current to an AC and DC ports, a control unit to control said first and second switches in accordance to said type of said current and configured to stop the current when said type of the current is not acceptable by said electric vehicle.

In one other embodiment, the cable has a sensing system detecting a type of said current, a control unit configured to control a switch to stop the current when the type of the current is not acceptable by said electric vehicle.

In one embodiment, the cable may have an ID reader for reading an ID of a charge port of the electric vehicle and communicating vehicle current information with said switch and a power supply to deliver said current accordingly.

In some embodiments, the cable may comprise a protective earthing conductor and/or one or more signal cables extending from said first end to said second end transferring data between the power supply and the electric vehicle.

In one example, the cable may further comprise a first phase-locked loop configured to connect to the signal cable of the electric vehicle and to the protective earthing conductor and a second phase-locked loop may to connect to a signal cable of the power supply and to the protective earthing conductor. The first phase-locked loop and the second phase-locked loop transmit the signal between the power supply and the electric vehicle through said protective earthing conductor.

In one embodiment, the cable further comprises a biometric recognition system which is used to confirm the identity of a user before allowing the current from the power supply to the electric vehicle.

### BRIEF DESCRIPTION OF THE DRAWINGS

The present examples will be better understood with reference to the appended illustrations which are as follows:

FIG. 1 illustrates a schematic illustration of an electric vehicle charging system capable of providing both AC and DC charging using only two conductors in accordance with an embodiment of the present invention.

FIG. 2A illustrates a cross-sectional view of a cable having an outer jacket and two conductors capable of providing an electrical vehicle with both AC and DC current.

FIG. 2B illustrates a cross-sectional view of a cable disclosed in accordance with one embodiment of the present disclosure having an outer jacket, two conductors and an earth ground conductor capable of providing an electrical vehicle with both AC and DC current.

FIG. 2C illustrates a cross-sectional view of a cable disclosed in accordance with one embodiment of the present disclosure having an outer jacket, two conductors, an earth ground conductor and two communication conductors capable of providing an electric vehicle with an AC or a DC current.

FIG. 3 illustrates a schematic illustration of an electric vehicle charging system capable of providing both AC and DC charging wherein a remote device is used to control the system in accordance with an embodiment of the present invention.

FIG. 4A shows a block diagram of the system in accordance with one embodiment of the present disclosure wherein an ID reader/controller communicates with the power supply and the car and controls two switches to deliver the current to the car accordingly.

FIG. 4B is a flowchart of the steps the system shown in FIG. 4A takes to deliver the current.

FIG. 4C illustrates a block diagram of the system in accordance with one embodiment of the present disclosure wherein a plug adaptor and connector adaptor only allow the cable to receive a certain type of current and to deliver it to the vehicle accordingly.

FIG. 5A shows a block diagram of the system in accordance with one embodiment of the present disclosure wherein a control unit communicates with the electric vehicle and the power supply and controls a switch accordingly.

FIG. 5B is a flowchart of the steps the system shown in FIG. 5A takes to deliver the current.

FIG. 6A illustrates a block diagram of the system in accordance with one embodiment of the present disclosure wherein a control unit communicates with a current sensor to controls two switches and to deliver the current it receives from the power supply to the electric vehicle.

FIG. 6B is a flowchart of the steps the system shown in FIG. 6A takes to deliver the current.

FIG. 7 illustrates a block diagram of the system in accordance with one embodiment of the present disclosure wherein a control unit communicates with the current sensor and a user interface to control two switches accordingly.

FIG. 8 illustrates a block diagram of the system in accordance with one embodiment of the present disclosure wherein the system has a memory to keep the information of a user which is required for charging the vehicle.

FIG. 9 illustrates a schematic illustration of an electric vehicle charging system with a locking mechanism to secure the cable.

### DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the scope of the invention. Thus, it is intended that the present invention cover the modifications and variations of this invention provided they come within the scope of the appended claims and their equivalents. Reference will now be made in detail to the preferred embodiments of the invention.

In one broad aspect, the present disclosure provides a system 100 for charging an electric vehicle. The system 100 comprises a cable 102 having a first end and a second end. The cable comprising a first conductor 204a and a second conductor 204b capable of conducting both AC current and DC current upon request, each extending from said first end to said second end. A plug 108 connects the first end to a power supply 404 and a connector 104 connects said second end to the electric vehicle. In some embodiments, such connection may need an adaptor such as a connector adaptor 430 or a plug adaptor 432.

The system 100 is further characterized by one of A) a sensing system for detecting a type of the current and a mechanism allowing an AC or DC adaptor to connect to said connector according to said type of said current; B) a sensing system detecting a type of said current; a first switch in the plug to receive said current from an AC or DC input of said power supply; a second switch in the connector for directing the current to an AC and DC ports; a control unit to control said first and second switches in accordance to said type of said current and configured to stop the current when said type of the current is not acceptable by said electric vehicle; or C) a sensing system detecting a type of said current; a control unit configured to control a switch to stop the current when said type of the current is not acceptable by said electric vehicle.

In one embodiment, the sensing system may be an ID reader for reading the ID of a charge port of the electric vehicle and communicating the vehicle's current information with the switch and a power supply to deliver said current accordingly.

In one alternative embodiment, the sensing system may be a current sensor attached to said cable communicating the type of current to the control unit controlling said switch to direct the current to deliver the current accordingly.

In one alternative embodiment, the control unit may communicate with an end device to choose the current type and the current to the electric vehicle.

In one alternative embodiment, the cable may further comprise a protective earthing conductor extending from the first and to the second. The cable may also have a signal cable or more extending from the first and to the second and transfers data between the power supply and the electric vehicle.

In one aspect, the system has a cable that may further comprise a first phase-locked loop configured to connect to the signal cable of the electric vehicle and to the protective earthing conductor and a second phase-locked loop may to connect to a signal cable of the power supply and to said protective earthing conductor. The first phase-locked loop and the second phase-locked loop transmit the signal between the power supply and the electric vehicle through said protective earthing conductor.

In some embodiments, the system may comprise a connector adaptor wherein the connector uses a connector adaptor to connect to the charge port of the electric vehicle.

In one embodiment, the system further comprises a biometric recognition system which is used to confirm the identity of a user before allowing the current from the power supply to the electric vehicle.

In another broad aspect, the present disclosure provides a charging cable for AC and DC charging with only two charging conductors. The cable comprising a first and a second conductor capable of conducting both AC and DC upon request, each extending from said first end to said second end, a connector attached to said second end having an AC port and a DC port.

In some embodiments, the cable further comprises a sensing system for detecting a type of said current and a mechanism allowing an AC or DC adaptor to connect to the connector according to said type of said current.

In some alternative embodiments, the cable comprises a sensing system for detecting a type of said current, a first switch in said plug to receive said current from an AC or DC input of said power supply, a second switch in said connector for directing the current to an AC and DC ports, a control unit to control said first and second switches in accordance to said type of said current and configured to stop the current when said type of the current is not acceptable by said electric vehicle.

In one other embodiment, the cable has a sensing system detecting a type of said current, a control unit configured to control a switch to stop the current when the type of the current is not acceptable by said electric vehicle.

In one embodiment, the cable may have an ID reader for reading an ID of a charge port of the electric vehicle and communicating vehicle current information with said switch and a power supply to deliver said current accordingly.

In some embodiments, the cable may comprise a protective earthing conductor and/or at least one signal cable extending from the first end to the second end transferring data between the power supply and the electric vehicle.

In one example, the cable may further comprise a first phase-locked loop configured to connect to the signal cable of the electric vehicle and the protective earthing conductor and a second phase-locked loop may connect to the signal cable of the power supply and to said protective earthing conductor. The first phase-locked loop and the second phase-locked loop transmit the signal between the power supply and the electric vehicle through said protective earthing conductor.

In one embodiment, the cable further comprises a biometric recognition system which is used to confirm the identity of a user before allowing the current from the power supply to the electric vehicle.

In one embodiment, an ID reader/controller may work as the sensing system and the control unit. The ID reader/controller communicates with a power supply and controls two switches to have the power supply deliver the corresponding type of current according to an ID of a charge port of the electric vehicle.

In another aspect, the control unit determines the type of the current using a current sensor or via communicating with the power supply and controls one or more switches to direct the current to the AC port or the DC port.

In an alternative embodiment, the control unit communicates with an end device such as a mobile device through an app to choose the current type and controlling one or more switches to direct the current to the AC or DC output of the cable.

In another aspect, the present disclosure provides a charging cable capable of both AC and DC charging using only two charging conductors each extending from one end of the cable to the other end. The cable also has a connector with an AC port and a DC port attached to one end of the cable, and one or more switches for directing the current to one of the AC and DC output ports corresponding to the type of said current. A control unit controls the switches and is capable of cutting the current when the type of the current is not acceptable by the electric vehicle.

In another embodiment, the control unit determines the type of the current by directly communicating with the power supply and or the electric vehicle and controls the switch to deliver the current to the vehicle accordingly.

In some embodiments, a current sensor 602 may be attached to the system 100 communicating the current information to the control unit which controls the switch to direct and deliver the current accordingly.

In some embodiments, the control unit may communicate with a mobile device 302 or any other wireless-capable device to choose the current type and to control one or more switch to direct the current to said AC port or to the DC port. This may be easily implemented through an app or a browser of the mobile device.

In another aspect the present disclosure provides a cable with a connector at one end and a plug at the other end, a controller, one or more switches that provide it with the ability to recognize and direct the current supplied from the power supply to the appropriate AC or DC output port of the cable.

Furthermore, the present disclosure provides a cable with the ability to cut the current if a mistake is made in terms of delivery of the current to the electric vehicle. For example, if a vehicle with only AC charging capability is connected to a DC power supply the cable would not allow the current to flow through. This safety feature can work independently or jointly with any safety mechanisms provided by the EV and/or the power supply.

The system receives the current from the power supply direct it through two conductors to the connector. After recognizing the type of current and ensuring that it is compatible with the current acceptable by the electrical vehicle, the system redirects the current toward a corresponding AC or DC port of the connector which will further connect directly to corresponding port of the electrical vehicle or connect to an adaptor that goes to the corresponding port of the electrical vehicle.

It will be appreciated by those skilled in the art that any type of conductor known in the art may be used in different embodiments. Some typical examples of the type of conductors are copper (Cu) and aluminum (Al). Copper is denser and heavier than aluminum, but more conductive than aluminum, therefore, an aluminum conductor has a cross-sectional area approximately 1.6 times larger than an electrically equivalent copper conductor, nevertheless, it is half the weight of the copper conductor. While the choice of the type of conductor used can affect the weight of the cable 102, it will not affect the way the present system functions.

Further, it will be appreciated by those skilled in the art that the cable 102 may benefit from different types of insulation, bedding, filler, armour, and sheath known in the art with the basic aim to safely provide adequate electrical power, with continuous, trouble-free operation, in a system that is able to withstand unexpected demands and possible overload conditions.

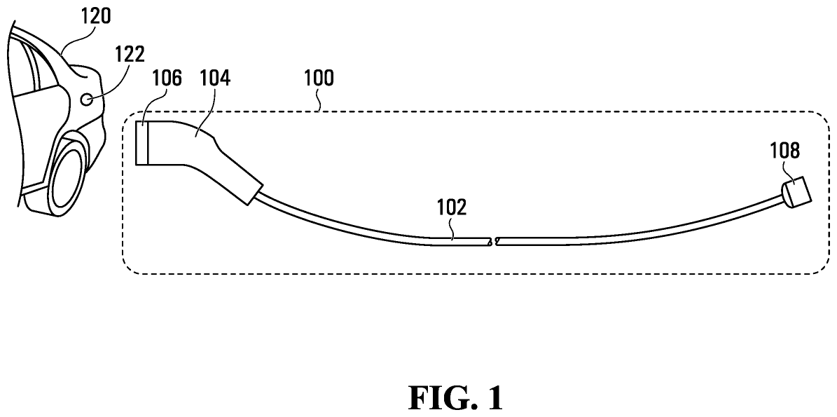

Reference is now made to FIG. 1, showing an exemplary vehicle charging system 100 comprising a cable 102 having a connector 104 at one end and a plug 108 at the other end.

As illustrated in FIG. 1, in some embodiments, the connector 104 connects to a connector adapter 106 to connect to a corresponding port 122 of an electric vehicle 120 and the plug 108 can also connect to a plug adaptor (not shown here) to connect to the power supply.

In an alternative embodiment, the connector 104 and the plug 108 may connect directly to the corresponding port 122 of an electric vehicle 120 or the power supply 404.

It will be appreciated by those skilled in the art that the cable 102 may directly connect to a power supply capable of providing both AC and DC current, and in some embodiments, there will be no need for a plug 108. The plug 108 provides a user with the ability to connect and disconnect the cable 102 from a power supply, hence, making the cable 102 more portable and easier to store within the vehicle 120.

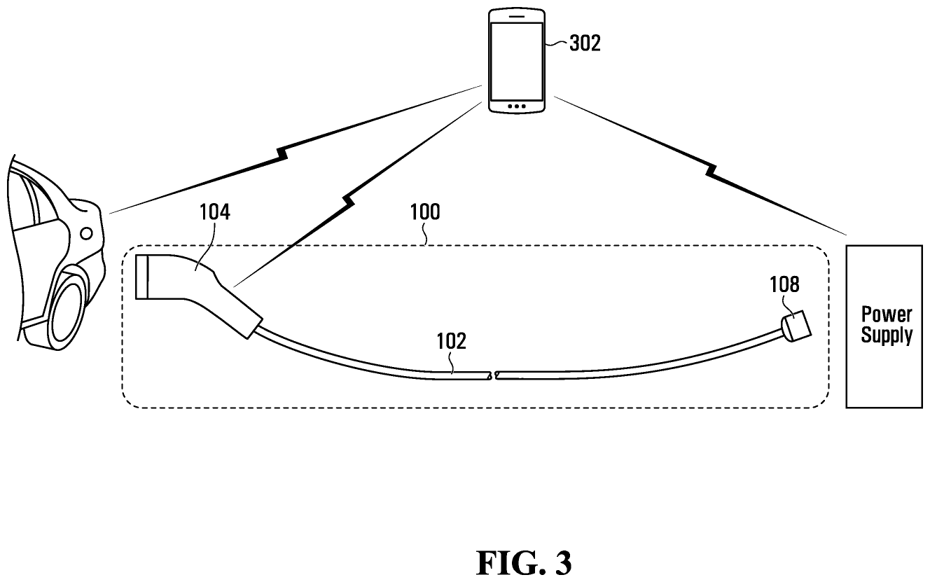

Referring to FIG. 3, in some embodiments, the system 100 is capable of communicating with an end device or mobile device 302 using a mobile application for letting the user know the battery is charged and communicate other information such as financial information for making the payment, current the vehicle accepts, voltage needed, time required for charging and other instructions.

In one embodiment, the system has a wireless communication module that can communicate with the mobile device 302. Alternatively, in some embodiments, the system may interact with the mobile device 302 through its connection with the electric vehicle 120 or the power supply's wireless network.

Moreover, in one embodiment, the mobile device 302 may communicate with the power supply through system 100 to authorize a transaction, authenticate a cable, transfer financial information of the user, choose the type of current and receive any information such as the charging status, the amount to be paid or other information. This may be achieved using the communication conductors 208a and 208b.

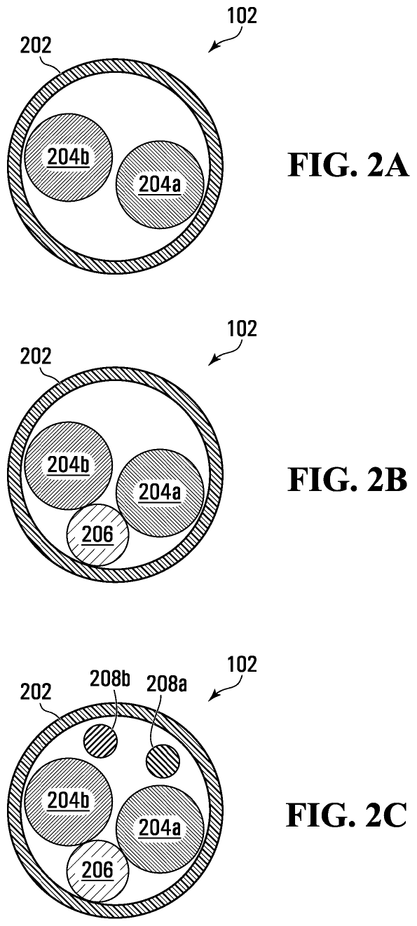

FIG. 2A illustrates a cross-sectional view of the cable 102, having an outer jacket 202 and the conductors 204a and 204b capable of providing and the electric vehicle 120 with an AC or a DC.

FIG. 2B shows an embodiment of the present wherein, in addition to two conductors 204 and 204b, the cable 102 has an earth ground conductor 206. An earth ground connection of the exposed conductive parts of electrical equipment helps protect from electric shock by keeping the exposed conductive surface of connected devices close to earth potential when a failure of electrical insulation occurs. When a fault occurs, current flows from the power system to earth. The current may be high enough to operate the overcurrent protection fuse or circuit breaker, which will then interrupt the circuit. To ensure the voltage on exposed surfaces is not too high, the impedance (resistance) of the connection to earth must be kept low relative to the normal circuit impedance.

FIG. 2C shows an embodiment of the present disclosure wherein, in addition to two conductors 204a and 204b and the earth ground conductor 206, the cable 102 has two communication conductors 208a and 208b which may be used for transferring information between the system 100 the vehicle 120 and the supply 404.

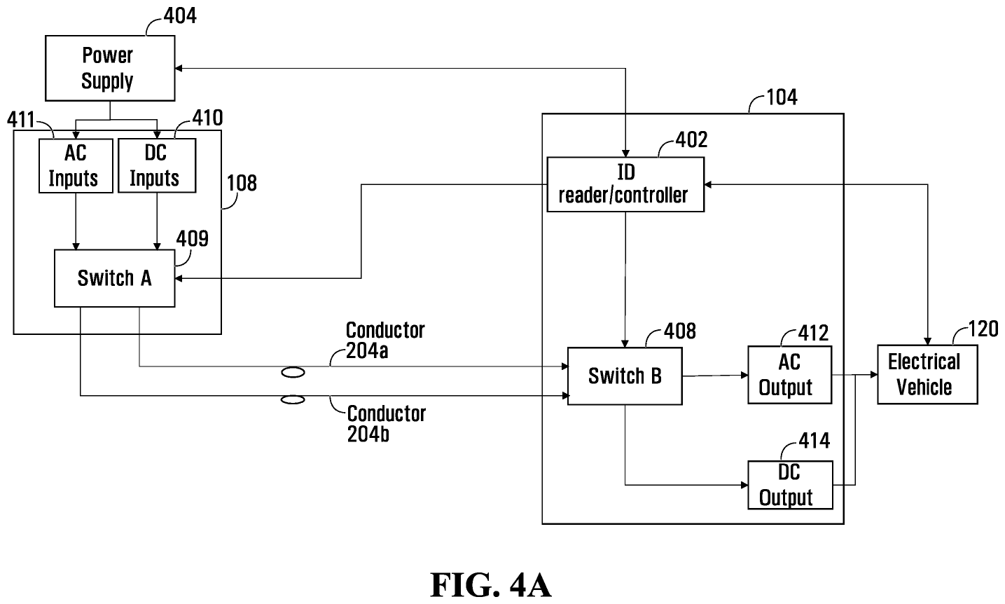

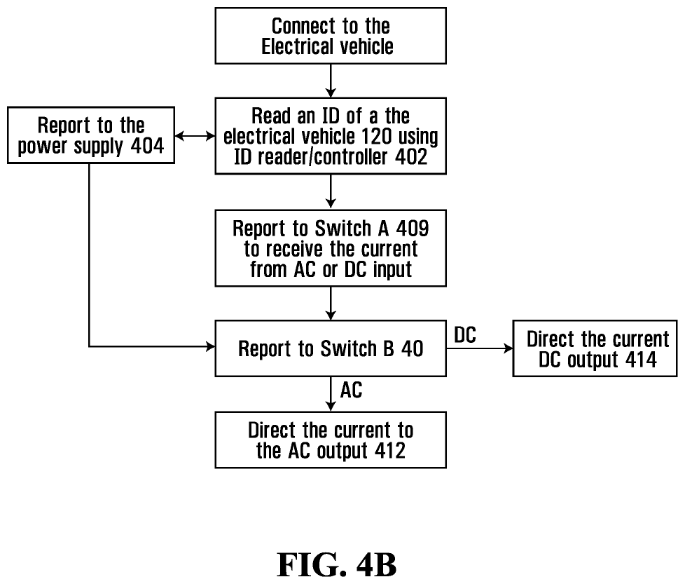

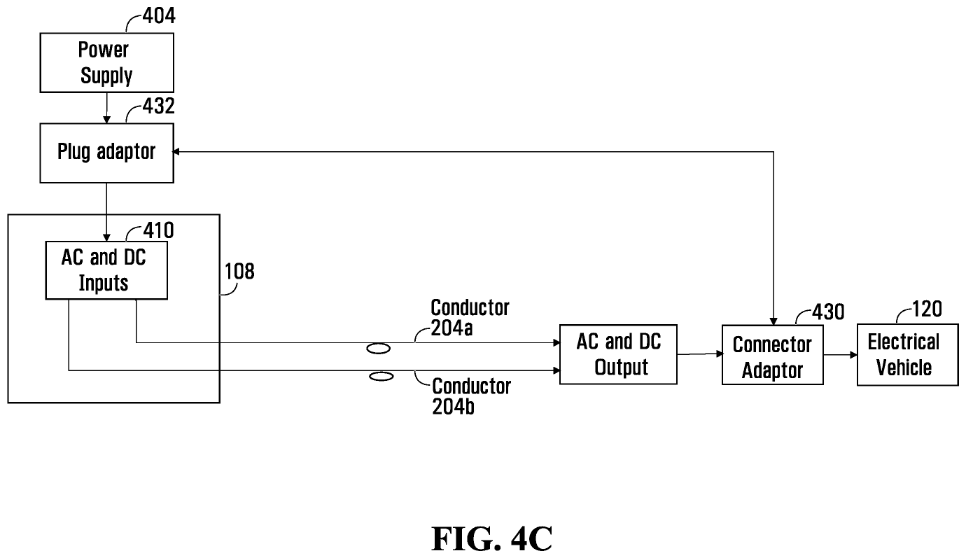

Reference is now made to FIG. 4A, in some embodiments, the plug 108 comprises an AC input 411 and a DC input 410 and a switch A 409 which connects them to the conductors 204a and 204b. At the other end, the connector 104 has and an ID reader/controller 402 as its sensing system which reads an ID of the charge port (not shown here) of the electric vehicle 120 to recognize the type of the current the vehicle needs or can receive. The ID reader/controller 402 may be any type of ID reader known in the art such as an RFID reader and an optical ID reader. Subsequently, using the information it receives through the ID reader, the system 100 ensures that the electric vehicle 120 receives the right type of current through an AC/DC input 410. This may be achieved through communication among the ID reader/controller 402, the power supply 404 and the switches 408 and 409.

FIG. 4B shows a flowchart of the steps the system 100 shown in FIG. 4A takes to redirect the current. After the system 100 is connected to the electric vehicle 120, the ID reader/controller 402 reads the ID information of the vehicle and reports it to the power supply 404 as well as the switches 408 and 409. The power supply 404 then provides the requested type of current and the switches 408 and 409 redirect the current to the appropriate output depending on the information provided by the ID information of the vehicle.

It will be appreciated by those skilled in the art that the ID information may contain other information such as the financial information of the vehicle owner to facilitate the charging of the vehicle without requiring the user to enter such information. In some embodiments, the ID information may be used in combination with other authentication methods such as using a mobile app to confirm transaction (using biometric measures, pin code etc. on the app) or having a pin protection or biometric security measures installed directly on the cable, the vehicle or the power supply.

As illustrated in FIG. 4C, in an alternative embodiment the system 100 may have a connector adaptor 430 and a plug adaptor 432 working as the sensing system for allowing a certain type of current to go through the conductor 204a and 204b. In this embodiment when an AC or DC adaptor is connected to one end of the cable, a mechanical or electrical connection mechanism will not allow a different type of adaptor to be connected to the other end. For example, if a user connects an AC plug adaptor to the cable it activates a solenoid that moves a connection pin at the other end and will only allow an AC connector adaptor to be connected to the cable.

It will be appreciated by those skilled in the art that in different embodiments the connection mechanism of the two adaptors may work and connect with each other by mechanically using a mechanical mechanism such as a cable or electrically by transferring a signal using the earth ground 206 conductor, the data cables 208a and 208b, an additional cable or wirelessly.

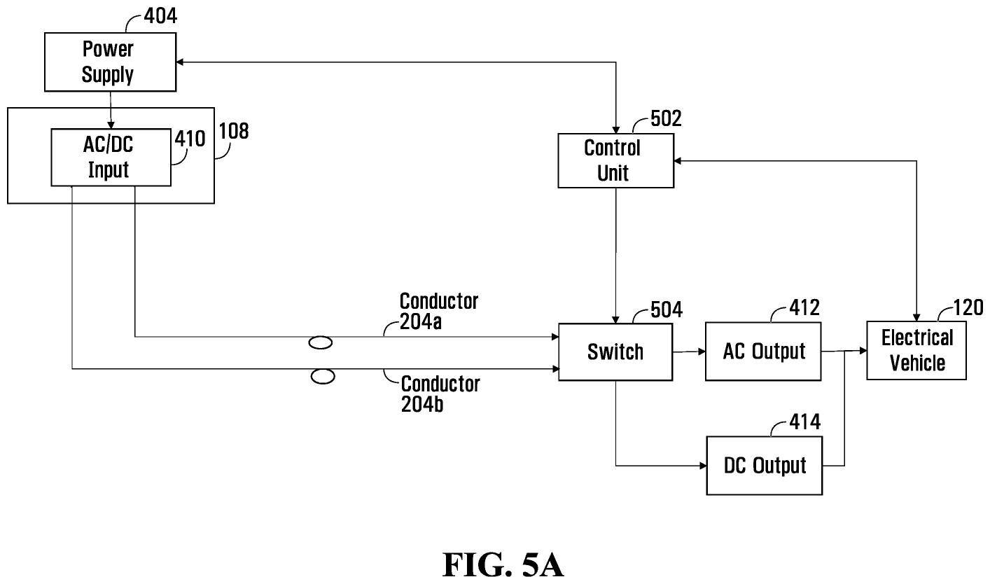

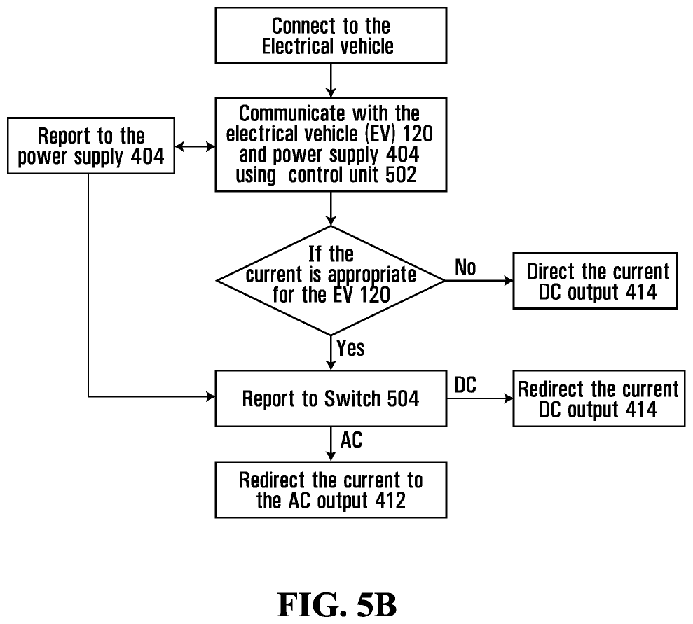

In another embodiment, as illustrated in FIG. 5A, the vehicle charging system 100 has a control unit 502 capable of controlling the switch 502. The controller 502 communicates with the power supply which works as the sensing system to recognize the type of current going through the conductors 204a and 204b and then controls the switch 504 to direct the current to the corresponding AC output 412 or DC output 414 of the connector 104 and from there to the electrical vehicle 122. If the electric vehicle is not capable of receiving the type of current sent from the power supply 404, the controller 502 would recognize that and control the switch 504 to cut the current and to avoid sending the wrong type of current to the vehicle. This ability provides system 100 with an extra layer of security to prevent possible damage to the electric vehicle 120 and its charging system.

FIG. 5B shows a flowchart of the steps the system 100 shown in FIG. 5A takes to redirect the current. After the system 100 is connected to the electric vehicle 120, the control unit 502 communicates with the vehicle 120 to get the information required regarding the type of current it accepts. The control unit 502 receives information regarding the type of current provided by the power supply 404 by communicating with the control unit 502. If the current is acceptable by the electric vehicle 120, the control unit 502 instructs the switch 408 to redirect it to the appropriate output accordingly. If not, it cut-offs the current to the electric vehicle 120 to avoid any undesired incidents. In one embodiment the control unit 502 can request from power supply 404 the appropriate type of current.

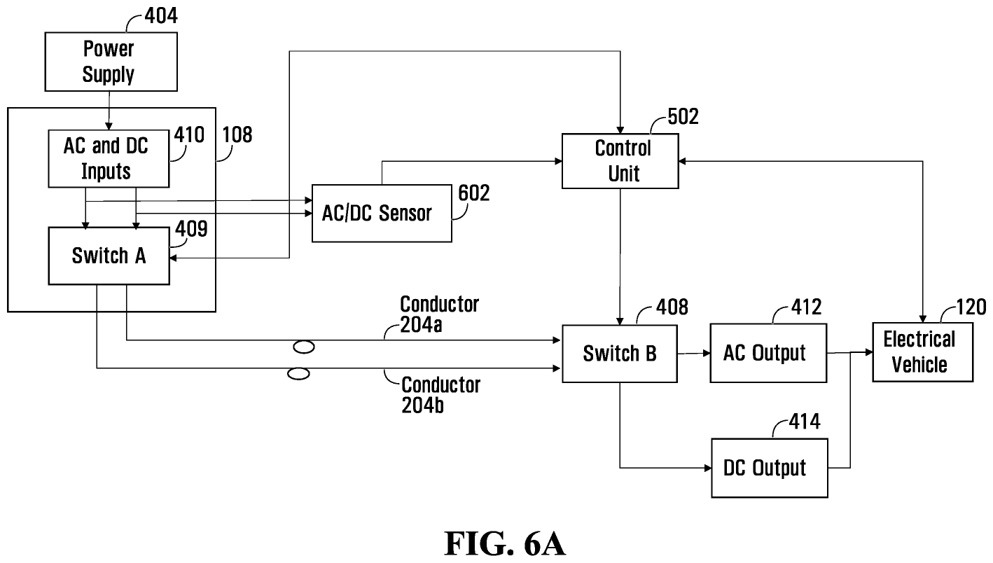

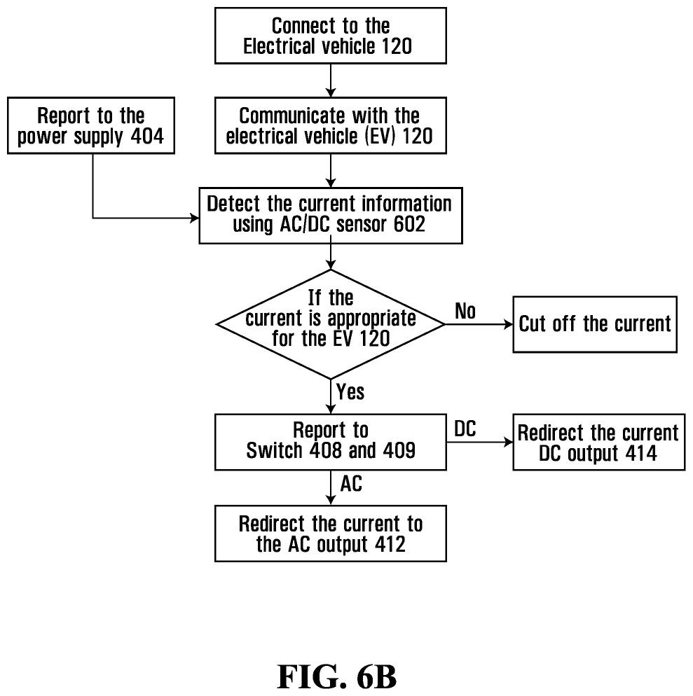

In another embodiment, as illustrated in FIG. 6A, the system 100 itself has an AC/DC sensor 602 as its sensing system which recognizes the type of current the cable receives and communicates the type of current to the control unit 502 to control the switches 408 and 409 accordingly directing the current to the corresponding output 412 or 414.

It will be appreciated by those skilled in the art that the sensor 602 can be any kind of current sensor known in the art and may be placed anywhere on the system 100.

FIG. 6B shows a flowchart of the steps the system 100 shown in FIG. 6A takes to redirect the current. After the system 100 is connected to the electric vehicle 120, the control unit 502 communicates with the vehicle 120 to get the information required regarding the type of current it accepts. The control unit 502 detects the type of current provided using the current sensor 602. If the current is acceptable by the electric vehicle 120, the control unit 502 instructs the switches 408 and 409 to redirect it to the appropriate output accordingly. If not, the control unit 502 cuts off the current to the electric vehicle 120 to avoid any undesired incidents.

Furthermore, it will be appreciated by those skilled in the art that the switch 504 may have the current sensor 602 and the control unit 402 embedded in it.

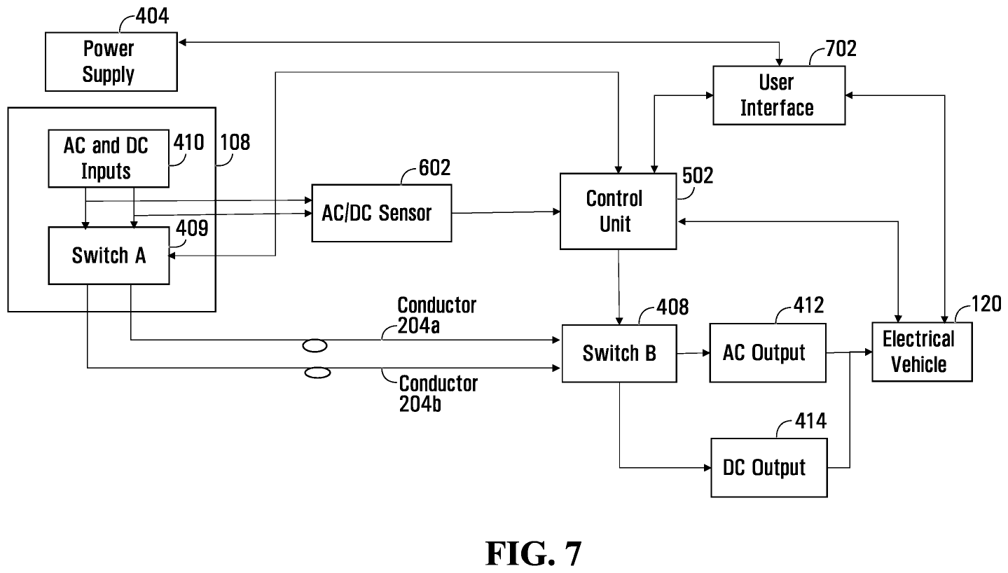

As illustrated in FIG. 7, in some embodiments, a user interface 702 can be used to communicate and control the different elements of the system 100, the power supply 404 and the electric vehicle 120. The user interface may communicate with the control unit 502 to give instructions to the system 100. In one alternative embodiment, the control unit 502 may be embedded in the user interface 702 to control the charging process.

In different embodiments, the user interface 702 may communicate with the system wirelessly, connect to the system using a wired connection or be embedded in a part of the system.

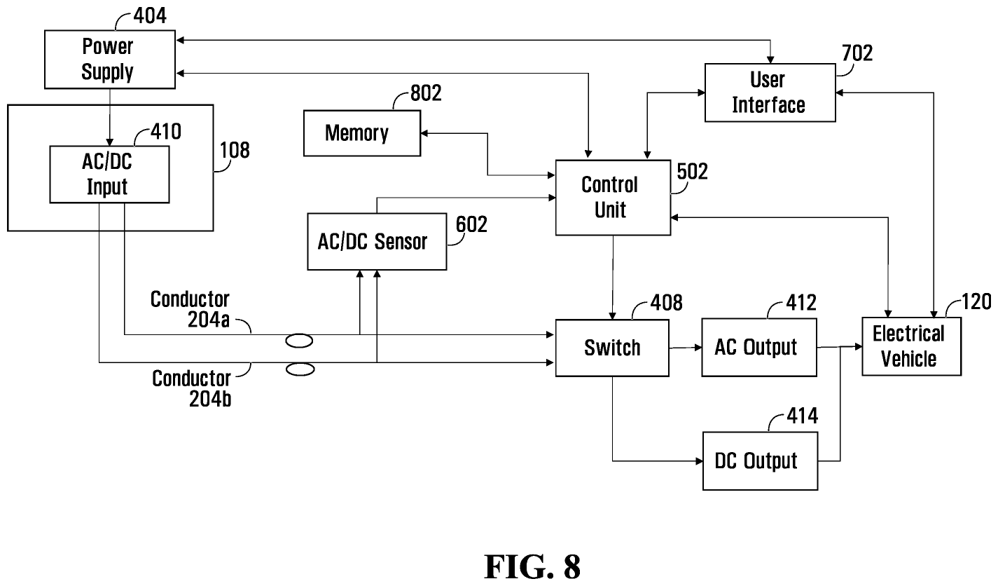

As illustrated in FIG. 8, in some embodiments, the system 100 has a memory 802 for storing information such as the user's credit card or other financial of the owner. The controller 502 is capable of retrieving the financial information or any other information from the memory 702 of the system and communicating this information with the power supply 404 the electric vehicle 120 or the user interface 702 as needed. This feature provides the user with the ability to connect the cable 102 to start charging the electric vehicle 120 without the need for entering financial information. In different embodiments, the authentication of the financial information may be done directly by the power supply 404 or through the user interface 702 or the electric vehicle 120.

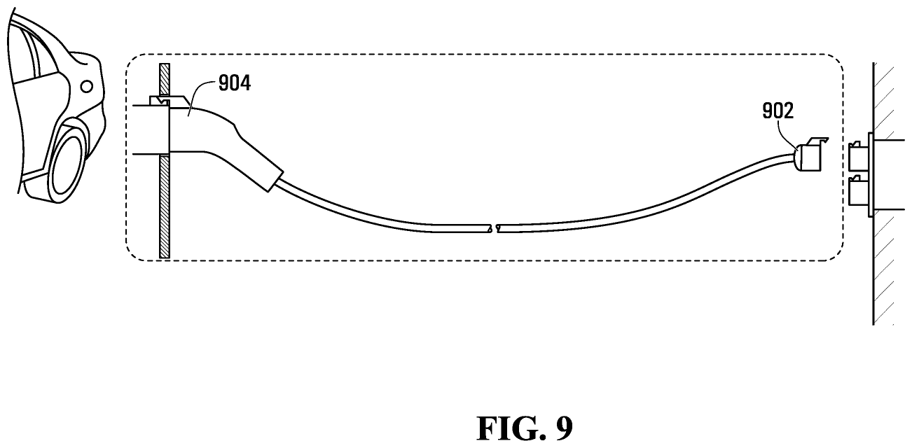

Referring to FIG. 9, in some examples, the system 100 may further comprise a supply locking system 902 for locking the cable 102 to the power supply station and or a car locking mechanism 904 to vehicle 120 or both. The locking system can be a simple physical lock as simple as a simple place for adding a padlock to a more advanced electronic locking system which would not allow an unauthorized user to disconnect the cable 102 or alternatively starts an alarm upon any unauthorized disconnection of the cable. Furthermore, the locking system may further be able to connect to the mobile device 140 through the control system 502 and alarm the owner about any unauthorized attempt to disconnect the cable 102.

In some embodiments, the present disclosure may use a biometric identifier locking system on the connector 104 to only allow authorized users to charge, connect or disconnect the cable from the vehicle or from the power supply of a charging station. The biometric information of the authorized users will be stored on the memory 602. A biometric identification reader such as a fingerprint reader may be used on the connector 104 to read the fingerprint of the person trying to use the system and communicates the fingerprint with the controller 402. The controller 402 confirms whether this information belongs to one of the authorized people as stored on the memory 602 and controls the switch 404 to allow the current and/or the locking system to allow the cable to be disconnected. This would provide the user with the ability to leave the vehicle unattended while charging at a public place without having the cable 102 stolen or being used for charging a different electrical vehicle.

Although the above description has been provided with reference to a specific example, this was for the purpose of illustrating, not limiting, the invention.

1. A system for charging an electric vehicle, the system comprising:
a cable having a first end and a second end, said cable comprising a first and a second conductor capable of conducting both AC and DC current upon request, each extending from said first end to said second end;
a plug for connecting said first end to a power supply;
a connector for connecting said second end to said electric vehicle;
wherein said system is further characterized by one of:
a sensing system for detecting a type of said current and a mechanism allowing an AC or DC adaptor to connect to said connector according to said type of said current;
a sensing system detecting a type of said current; a first switch in said plug to receive said current from an AC or DC input of said power supply;
a second switch in said connector for directing the current to an AC and DC ports; a control unit to control said first and second switches in accordance to said type of said current and configured to stop the current when said type of the current is not acceptable by said electric vehicle;
a sensing system detecting a type of said current; a control unit configured to control a switch to stop the current when said type of the current is not acceptable by said electric vehicle.

2. The system in claim 1 wherein said sensing system is an ID reader for reading an ID of a charge port of the electric vehicle and communicating vehicle current information with said switch and a power supply to deliver said current accordingly.

3. The system in claim 1 wherein said sensing system is a current sensor attached to said cable communicating said type of the current to said control unit controlling said switch to direct the current to deliver said current accordingly.

4. The system in claim 1 wherein said control unit in B and C communicate with an end device to choose the current type and the current to said electrical vehicle.

5. The system in claim 1, wherein the cable further comprises a protective earthing conductor extending from said first end to said second.

6. The system in claim 1, wherein the cable further comprises at least one signal cable extending from said first end to said second end transferring data between the power supply and the electric vehicle.

7. The system in claim 5, wherein the cable further comprises:
a first phase-locked loop configured to connect to a signal cable of the electric vehicle and to said protective earthing conductor;
a second phase-locked loop configured to connect to a signal cable of the power supply and to said protective earthing conductor;
wherein the first phase-locked loop the first and the second phase-locked loop transmit signal between the power supply and the electric vehicle through said protective earthing conductor.

8. The system in claim 1, further comprising a connector adaptor wherein the connector uses a connector adaptor to connect to the charge port of the electric vehicle.

9. The system in claim 1, further comprising a biometric recognition system wherein the connector uses said biometric recognition system to confirm the identity of a user before allowing the current from the power supply to the electric vehicle.

10. A charging cable for AC and DC charging, the charging cable comprising:
a first and a second charging conductors capable of conducting both AC current and DC current upon request, each extending from a first end of the cable to a second end of the cable;
a connector attached to said second end having an AC port and a DC port;
wherein said cable is further characterized by one of:
a sensing system for detecting a type of said current and a mechanism allowing an AC or DC adaptor to connect to said connector according to said type of said current;
a sensing system detecting a type of said current; a first switch in said plug to receive said current from an AC or DC input of said power supply;
a second switch in said connector for directing the current to an AC and DC ports; a control unit to control said first and second switches in accordance to said type of said current and configured to stop the current when said type of the current is not acceptable by said electric vehicle;
a sensing system detecting a type of said current; a control unit configured to control a switch to stop the current when said type of the current is not acceptable by said electric vehicle.

11. The charging cable of claim 10, further comprising an ID reader for reading an ID of a charge port of the electric vehicle and communicating vehicle current information with said switch and a power supply to deliver said current accordingly.

12. The charging cable in claim 10, further comprising a protective earthing conductor extending from said first end to said second end transferring data between the power supply and the electric vehicle.

13. The charging cable in claim 10, further comprising at least one signal cable extending from said first end to said second end transferring data between the power supply and the electric vehicle.

14. The charging cable in claim 11, further comprising:
a first phase-locked loop configured to connect to a signal cable of the electric vehicle and to said protective earthing conductor;
a second phase-locked loop configured to connect to a signal cable of the power supply and to said protective earthing conductor;
wherein the first phase-locked loop the first and the second phase-locked loop transmit signals between the power supply and the electric vehicle through said protective earthing conductor.

15. The charging cable in claim 10, further comprising a biometric recognition system wherein the connector uses said biometric recognition system to confirm the identity of a user before allowing the current from the power supply to the electric vehicle.

16. The system of claim 6, wherein a number of said at least one signal cable is determined based on said any type of communication protocol used between the electric vehicle and said power supply.

17. The charging cable of claim 13, wherein a number of said at least one signal cable is determined based on said any type of communication protocol used between the electric vehicle and said power supply.
